(19) United States
(12) Patent Application Publication
(10) Pub. No.: US 2026/0203395 A1
(43) Pub. Date: Jul. 16, 2026

(54) PROTECTION OF COMPARISON OPERATIONS AGAINST SIDE-CHANNEL ATTACKS IN CRYPTOGRAPHIC APPLICATIONS

(71) Applicant: Cryptography Research, Inc., San Jose, CA (US)

(72) Inventors: Qinglai Xiao, Espoo (FI); Michael Alexander Hamburg, Rosmalen (NL)

(21) Appl. No.: 19/446,679

(22) Filed: Jan. 12, 2026

Related U.S. Application Data
(60) Provisional application No. 63/745,695, filed on Jan. 15, 2025.
(60) Provisional application No. 63/770,644, filed on Mar. 12, 2025.

(51) Int. Cl. G06F 21/54; G06F 17/16; G06F 21/60

(52) U.S. Cl. CPC G06F 21/54; G06F 17/16; G06F 21/602

(57) ABSTRACT

Disclosed aspects and implementations are directed to systems and techniques for efficient randomization-protected comparison operations deploying linear transformations and or matrix multiplications in the context of processing an input into the cryptographic operation. The disclosed techniques include obtaining a masked representation of a first vector and a second vector, the masked representation including shares of the first vector and the second vector or shares of a difference of the first vector and the second vector. The techniques further include transforming, using a matrix-based randomization operation, the masked representation to a transformed representation and obtaining, using the transformed representation, a determination whether the first vector is equal to the second vector. The techniques further include computing, using the determination, an output of the cryptographic operation associated with the input into the cryptographic operation.

### CLAIM OF PRIORITY

The present application claims the benefit under 35 U.S.C. § 119(e) of U.S. Provisional Patent Application No. 63/770,644, filed Mar. 12, 2025 and U.S. Provisional Patent Application No. 63/745,695, filed Jan. 15, 2025, the contents of both applications being incorporated in their entirety by reference herein.

### TECHNICAL FIELD

Aspects of the present disclosure are directed to cryptographic computing applications, more specifically to protection of cryptographic operations against side-channel attacks.

### BRIEF DESCRIPTION OF THE DRAWINGS

The present disclosure will be understood more fully from the detailed description given below and from the accompanying drawings of various implementations of the disclosure.

FIG. 1A illustrates an example computing architecture that supports randomization-protected comparison operations in cryptographic applications, in accordance with one or more aspects of the present disclosure.

FIG. 1B illustrates another example computing architecture that supports randomization-protected comparison operations in cryptographic applications, in accordance with one or more aspects of the present disclosure.

FIG. 2 illustrates schematically operations of randomization-protected comparisons deploying linear transformations, in accordance with one or more aspects of the present disclosure.

FIG. 3 illustrates schematically another set of operations of randomization-protected comparisons deploying linear transformations, in accordance with one or more aspects of the present disclosure.

FIG. 4 is a block diagram illustrating an example computing platform capable of supporting randomization-protected comparison operations for efficient implementation of cryptographic applications, in accordance with one or more aspects of the present disclosure.

FIG. 5 depicts a flow diagram of an example method of using randomization-protected comparison operations deploying linear transformations and or matrix multiplications in cryptographic applications, in accordance with one or more aspects of the present disclosure.

FIG. 6 depicts a flow diagram of an example method of implementing randomization-protected comparison operations that deploy linear transformations and or matrix multiplications in conjunction with splitting into blocks, in accordance with one or more aspects of the present disclosure.

FIG. 7 depicts a block diagram of an example computer system operating in accordance with one or more aspects of the present disclosure.

### DETAILED DESCRIPTION

In public-key cryptography systems, a processing device may have various components/modules used for cryptographic operations on input messages, which are typically represented via large integers. Cryptographic algorithms often involve modular arithmetic operations with modulus q, in which the set of all integers Z is wrapped around a circle of length q (the set Z_{q}), so that any two numbers that differ by q (or any other integer multiple of q) are congruent to (and treated as) the same number within Z_{q}. Pre-quantum cryptographic applications—such as the Rivest-Shamir-Adelman (RSA) algorithm, digital signature algorithms (DSA), Diffie-Hellman key exchange (DHKE) algorithms, Elliptic Curve Cryptography (ECC) algorithms, and the like—exploit the fact that solving an integer factorization problem, a discrete logarithm problem, an elliptic curve discrete logarithm problem, and/or the like, involves prohibitively difficult operations (for large moduli q) on a classical computer.

Progress in quantum computing technology has placed conventional public key encryption schemes into jeopardy. In response, in 2016, the National Institute of Standards and Technology (NIST) initiated a Post-Quantum Cryptography (PQC) standardization process to promote development of public-key cryptographic algorithms that are resistant against attacks using quantum computers. In July 2022, after rigorous analysis and evaluation, NIST has selected the following algorithms: CRYSTALS-DILITHIUM digital signatures algorithm, selected under the name ML-DSA (various versions of such algorithms referred to as “Dilithium” herein), CRYSTALS-KYBER key encapsulation mechanism, selected under the name ML-KEM (various versions of such algorithms referred to as “Kyber” herein), FALCON digital signatures algorithm, and SPHINCS+hash-based signature algorithm. In particular, NIST recommended Dilithium as the primary signature algorithm. Additional key encapsulation algorithms are currently considered, including BIKE, Classic McEliece, and HQC. Further NIST competitions have been initiated for signature algorithms that are based on different mathematical foundations.

As an example, the Kyber algorithm is based on the Learning-With-Errors (LWE) problem on structured lattices with the underlying operations involving matrix-vector and/or vector-vector multiplications with the elements of the matrices/vectors are polynomials defined on a ring R_{q}=Z_{q}[x]/(xⁿ+1), namely polynomials with coefficients in Z_{q} and polynomial operations defined modulo the modulus polynomial xⁿ+1. The Kyber decapsulation algorithm includes a verification step where a comparison of two d-dimensional vectors (strings of d values used together in computations of the algorithms), e.g., V and W, is performed by checking (“zero-check” herein) whether the difference V−W is zero or non-zero. For example, a shared secret key may be generated by decrypting a ciphertext using a decryption key to obtain a plaintext, which is subsequently re-encrypted using an encryption key (and, possibly, various additional random values and/or hashes) to obtain a verification ciphertext. If the verification ciphertext does not match the shared secret key is rejected. This check is performed to prevent attacks involving corrupted ciphertexts where an attacker uses a different ciphertext and attempts to determine whether the decrypted plaintext remains the same or is also changed (and to what degree). The zero-check stops such attacks since it detects changes to the ciphertext should not do this in a way that leaks information about the inputted ciphertexts (at least one of which is secret). As one of the vectors V or W can be secret while the other vector engineered by an adversarial attacker that causes the algorithm to run multiple such comparison checks, the attacker who obtains information on a degree of difference between vectors V and W (e.g., in which elements the vectors differ, the Hamming distance between elements, and/or the like) can collect enough statistical data to determine the secret vector.

Aspects and implementations of the instant disclosure address these and other challenges of the cryptographic technology by providing for systems and techniques that protect comparison operations from adversarial attacks. The disclosed techniques do not reveal any information about values of the vectors being compared other than whether the vectors are the same or different (but not how different) and include multiple levels of cryptographic protections. For example, the compared vectors may be masked using a representation in which the vectors are split into shares, e.g., V=V₁+V₂ . . . , such that comparison computations are performed on individual shares Vⱼ and Wⱼ with the unmasking performed late in the process, e.g., during the final where the difference D=V−W is compared to zero. In some implementations, the (masked) difference is first multiplied by a random matrix M of size m×d and a masked difference D_{M}=M*(V₁−W₁)+M*(V₂−W₂)+ . . . . Such a random matrix has a progressively decreased probability of producing an accidental zero, D_{M}=0 (while the true difference is nonzero, D≠0) provided that the random matrix is selected to have a sufficiently large height m (the width of the matrix being fixed by dimensionality d of the compared vectors), e.g., m=16, 20, 24, 32, and/or the like. In other embodiments, for faster comparisons, the matrix M is not selected randomly, but represents a matrix of suitable non-random transformation, such as a Number Theoretical Transform (NTT), Fast Fourier Transform (FTT), Additive Fast Fourier Transform, Reed-Solomon code transform, and/or another linear transform associated with a maximum distance separable (MDS) matrix T (e.g., a square N×N matrix). Processors and hardware accelerators may include special circuitry for fast performance of such linear transforms. Since linear transforms implementing known algorithms lack randomness, zero-check protections may additionally include a randomization operation where shares of the difference are randomized with multiplication by a random vector r with non-zero elements, e.g.,

$${D}_{T} = T * [ r ∘ ( {V}_{1} - {W}_{1} ) ] + T * [ r ∘ ( {V}_{2} - {W}_{2} ) ] + ⋯ ,$$

where symbol ∘ indicates a pointwise (Hadamard) product of individual elements of vectors r and Vⱼ−Wⱼ (in some instances, the pointwise multiplication may involve more than one element from each vector, e.g., pairwise multiplications used in the Kyber algorithm, and/or the like).

In some applications, a full n-point NTT (or some other MDS transform) may not exist. For example, Kyber uses the modulus polynomial x²⁵⁶+1, that does not factorize into a product of n=256 linear polynomials but factorizes into n/2=128 quadratic polynomials. In such instances, the NTT may be used to implement two n/2-point NTTs, separately for even-numbered and odd-numbered coefficients. Correspondingly, the use of pairwise-elementwise multiplication over the extension field F_{q}_{²} makes the Kyber NTT into an MDS transform even though it is not an MDS over F_{q}. Accordingly, throughout this disclosure, the terms “MDS transform” and/or “MDS matrix” are to be understood to include transforms/matrices that are MDS over any suitable extended fields (e.g., F_{q}_{²}) and not only over the field F_{q}. The disclosed implementations operating over such extended fields are capable of ensuring cryptographic protections of zero-check operations since multiplications in such instances are pairwise-elementwise (pairwise-pointwise) multiplications.

In some implementations, to speed-up the zero-check computations, the linear transform T need not be computed fully; instead, first p elements of each share T*[r∘(Vⱼ−Wⱼ)] may be computed, e.g., p=n/2, p=n/4, and/or the like, or some fixed number, e.g., p=10, 12, 16, and/or the like. The MSD nature of the transform T ensures that a portion (of size p) of the elements of T*[r∘(Vⱼ−Wⱼ)] may be sufficient to ensure that the zero-check is reliable enough, such that when V−W≠0, and all elements of the portion unmasked (summed) over the shares, ΣⱼT*[r∘(Vⱼ−Wⱼ)], the probability that these elements are all zero is negligible. In those instances where at least one unmasked element of the portion is non-zero, the zero-check positively determines that the difference D_{T}≠0.

In some implementations, where the dimensionality of the vectors d exceeds the dimensionality N of the linear transform (as may be supported by the hardware accelerator, e.g., N=256), n=d/N linear transforms may be performed, each of the n transforms performed for a respective block of N elements of vectors Vⱼ and

$${W}_{j} ( e . g . , such that {V}_{j} = ( {V}_{j}^{( 1 )} … {V}_{j}^{( n )} ) ) .$$

In some implementations, a kth block

$${V}_{j}^{( k )}$$

of jth share Vⱼ of vector V (and, similarly of vector W) may be randomized by a block-specific N×1 random vector r^{(k)} (selected to be the same across different shares). The zero-check may then verify whether the unmasked block-values

$${D}_{T}^{( k )} = {\sum }_{j} T * [ {r}^{( k )} ∘ ( {V}_{j}^{( k )} - {W}_{j}^{( k )} ) ]$$

computed for various blocks k are zero. In some implementations, the zero-check may include summing over all blocks and determining whether the difference

$${D}_{T} ≡ {\sum }_{k} {D}_{T}^{( k )} = {\sum }_{k} {\sum }_{j} T * [ {r}^{( k )} ∘ ( {V}_{j}^{( k )} - {W}_{j}^{( k )} ) ]$$

is zero. In yet other implementations, for additional protections, a set of block-sized N-dimensional random masking vectors {s^{(k)}} for re-randomization of block-level outputs may be selected to compute the re-randomized difference

$${D}_{T} = {\sum }_{k} {s}^{( k )} ∘ {D}_{T}^{( k )} .$$

Various other implementations are disclosed herein.

The advantages of the disclosed techniques include (but are not limited to) efficient protections of comparison operations against side-channel attacks. The techniques include several layers of protection, such as one or more randomizations and masking (via shares) of intermediate calculations until the final determination is made. The disclosed techniques may be efficiently performed using hardware accelerators or processors configured to perform one or more MDS transforms.

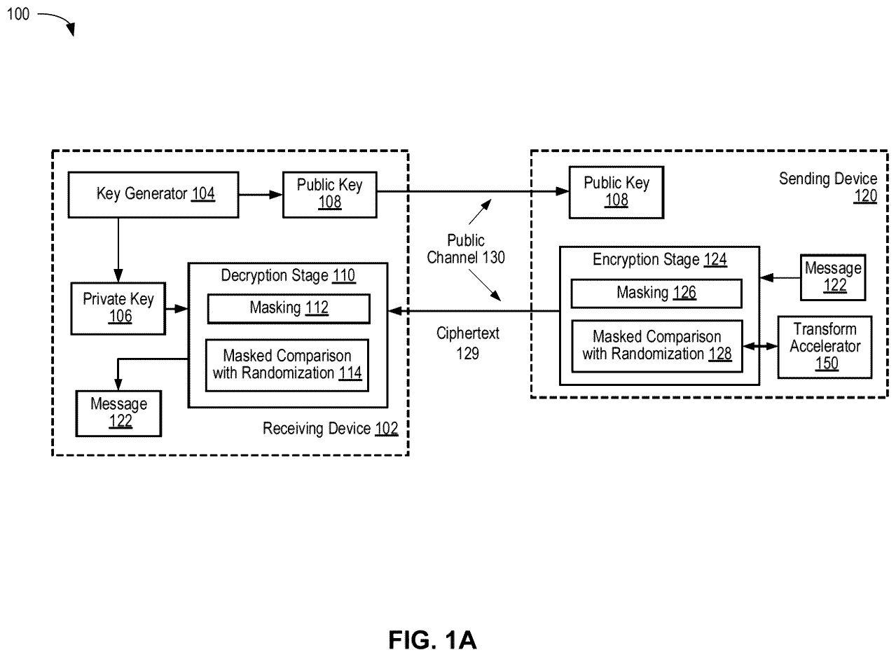

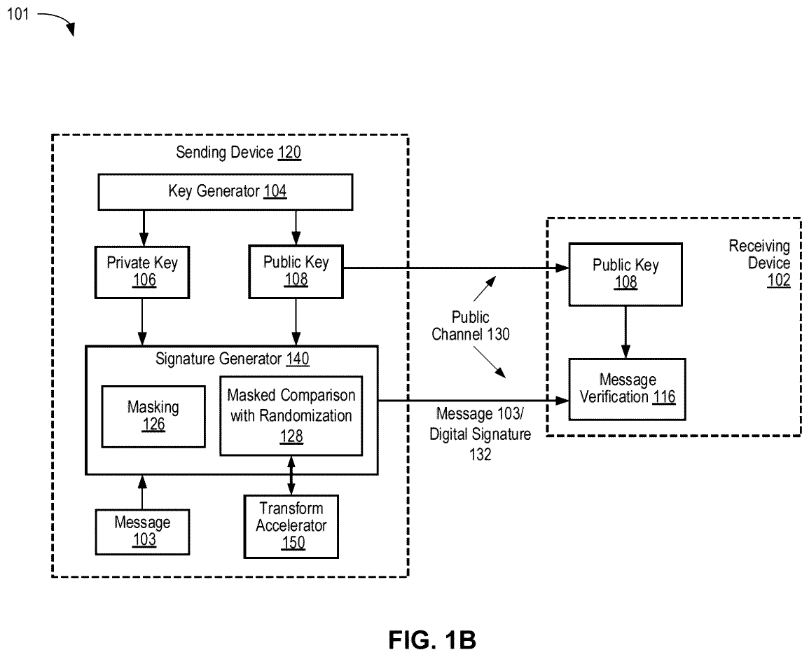

FIG. 1A illustrates an example computing architecture 100 that supports randomization-protected comparison operations in cryptographic applications, in accordance with one or more aspects of the present disclosure. In some implementations, computing architecture 100 implements public/private key cryptographic applications, Kyber key encapsulation applications, and/or other cryptographic applications. Computing architecture 100 may include various components/modules/applications that are not explicitly depicted in FIG. 1A, including but not limited to various domain-specific applications that perform operations on output or input messages. Computing architecture 100 may include a receiving device 102 deploying a cryptographic application-specific key generator 104 that may generate a private key 106 and a public key 108. Receiving device 102 may provide public key 108 to a sending device 120 that uses public key 108 to encrypt a message 122 before sending ciphertext (encrypted message) 129 over a public communication channel 130, which may include any network, e.g., Internet, local area network, wide area network, and/or the like. In some implementations, message 122 may encapsulate a symmetric key provided to receiving device 102 to establish secure communication between receiving device 102 and sending device 120 over a public communication channel 130. Message 122 may be encrypted by an encryption stage 124 implementing a suitable encryption scheme. In some implementations, the encryption scheme may be one of the post-quantum encryption schemes, including but not limited to Kyber, and/or other similar algorithms.

Encryption stage 124 may include a masking logic 126 that represents secret data (and various non-secret data that is used in computations together with the secret data) via multiple shares to reduce exposure of the secret data to potential attacks. For example, random masking vector m may be generated and subtracted from a secret vector A to generate a first share A₁=A−m of the secret vector with the masking vector itself being used as the other share of the secret data, A₂≡m, such that leaking some knowledge about one of the shares does not reveal the secret data unless an attacker also gains knowledge about other share(s). In some implementations, e.g., in the instances of XOR (modulo 2) additions where (bitwise) subtraction is equivalent to addition, masking may be performed as A₁=A⊕m, A₂≡m, with the secret vector given by another XOR addition of the shares, A=A₁⊕A₂. Although in this example, the number of shares is two, any other number of shares may be used for improved protection and additional obfuscation of secret data from attacks.

Encryption stage 124 may further include a masked comparison with randomization 128 to apply a suitable linear transformation, e.g., NTT, FFT, AFFT, Reed-Solomon, and/or the like, that performs comparison of vectors V and W (of which one or more may be secret) by performing a zero-check (“V−W=0?”). The zero-check may include applying the linear transform to shares of input vectors, which may be additionally randomized (using one or multiple instances of randomization) with the final verification performed by combining transformed/randomized shares. In some implementations, masked comparison with randomization 128 may deploy a transform accelerator 150, which may be a hardware device that speeds up operations of the linear transform. Transform accelerator 150 may be implemented as part of a main processor of sending device 120 (not shown explicitly in FIG. 1A) or as a co-processor that is separate from the main processor.

Receiving device 102 may process the received ciphertext 129 using decryption stage 110 and recover message 122 using private key 106. Decryption stage 110 may also include a masking logic 112 that operates similar to masking logic 126 of the encryption stage 124 and may further include a masked comparison with randomization 114 that operates similarly to masked comparison with randomization 128 of the encryption stage 124 to protect secret data (e.g., private key 106, message 122, and/or the like) against side-channel attacks. Although, for illustration, ciphertext(s) and plaintext(s) (decrypted messages) are generated/processed by different devices in the illustration of FIG. 1A, in some instances ciphertext(s) and plaintext(s) may be generated/processed by the same device. For example, sending device 120 may be the same device as receiving device 102. Although not depicted explicitly, receiving device 102 may also deploy a transform accelerator that is similar to transform accelerator 150 on sending device 120. Furthermore, although FIG. 1A shows masked comparison with randomization is shown as part of both the decryption stage 110 and the encryption stage 124, in various implementations (e.g., in Kyber applications) masked comparison with randomization may be performed as part of the decryption stage 110 but not the encryption stage 124. In some implementations, masked comparison with randomization may be performed as part of is shown as part of the encryption stage 124 but not the decryption stage 110.

FIG. 1B illustrates another example computing architecture 101 that supports randomization-protected comparison operations in cryptographic applications, in accordance with one or more aspects of the present disclosure. Computing architecture 101 may implement message authentication using digital signature algorithms, e.g., Dilithium digital signature algorithms, and/or other cryptographic applications. As illustrated in FIG. 1B, sending device 120 may deploy key generator 104 that generates private key 106 and public key 108. Sending device 120 may provide public key 108 to receiving device 102. Sending device 120 may include a signature generator 140 that authenticates message 103 using private key 106 or a combination of private key 106 and public key 108. In some implementations, signature generator 140 may include masking logic 126 and masked comparison with randomization 128 to protect secret data (e.g., private key 106, message 103, and/or the like) against side-channel attacks during comparison (zero-check) operations.

Sending device 120 may send message 103 together with digital signature 132 produced by signature generator 140 to receiving device 102 over public communication channel 130. Receiving device 102 may use public key 108 to perform message verification 116 to verify digital signature 132. In some implementations, the digital signature scheme may be one of the post-quantum digital signature schemes, including but not limited to Dilithium, and/or the like. Although, in the illustration of FIG. 1B different devices perform a signature generation and verification, in some instances both algorithms may be performed by the same device (e.g., with sending device 120 being the same as receiving device 102).

Although FIG. 1A and FIG. 1B illustrate various blocks and components that perform operations of the instant disclosure, various additional blocks and components may perform any other masking and obfuscation operations to protect secret data during other (than comparisons/zero-checks) computations associated with any cryptographic algorithms that may be deployed on receiving device 102 and/or sending device 120.

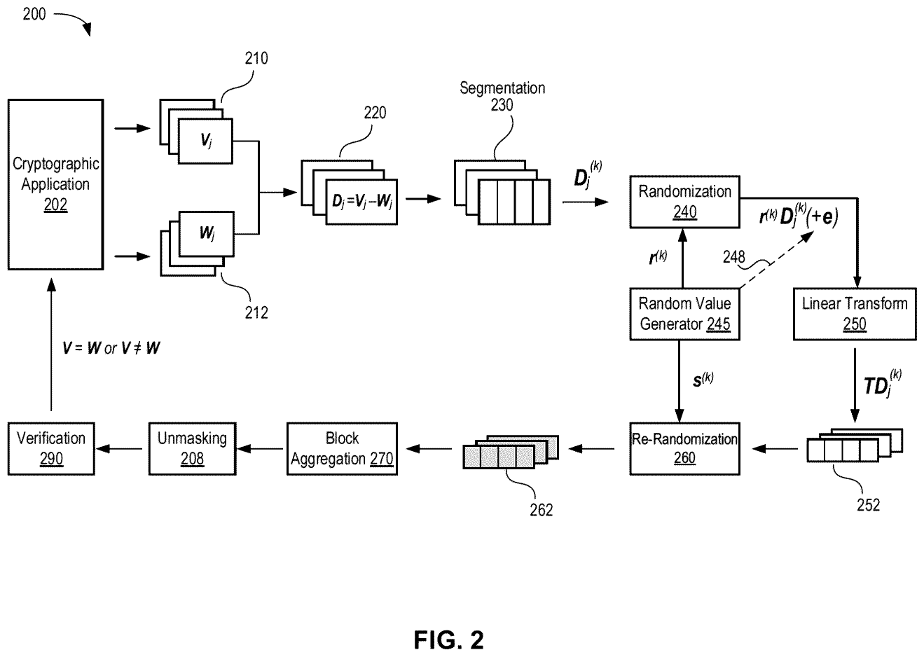

FIG. 2 illustrates schematically operations 200 of randomization-protected comparison operations deploying linear transformations, in accordance with one or more aspects of the present disclosure. Operations 200 can be performed to encrypt, decrypt, and/or authenticate any suitable message by a cryptographic application 202. In some implementations, operations 200 may include comparison of d×1 vectors V and W, e.g., any strings of d values or elements that may be used and/or stored/communicated together in or used together in conjunction with particular cryptographic operations. For example, a k×l matrix A may be multiplied by vector V to generate the k×1 vector A*V according to rules of linear algebra. In some implementations, elements of a vector or matrix may be single-bit values. In some implementations, elements of a vector or matrix may be multi-bit values. In some implementations, elements of a vector or matrix may be element of the Galois field GF(2^{L}), e.g., polynomials of order L−1 with the addition (and multiplication) operations defined modulo 2 (bitwise XOR operations) and the multiplication (and division) operations defined modulo a suitably chosen irreducible polynomial of order L (e.g., L=8 for one-byte elements). For example, an L-bit value m_{L-1} . . . m₁m₀ may be mapped on the polynomial

$$m ( x ) = {\sum }_{j = 0}^{L - 1} {m}_{j} {x}^{j}$$

in the Galois field GF(2_{L}).

In some implementations, vector 210 V may be represented via shares V=V₁+V₂ . . . , and vector 212 W may similarly be represented via shares W=W₁+W₂ . . . . Operations 200 may include computing differences 220 of the respective shares, Dⱼ=Vⱼ−Wⱼ. (In those implementations where addition and subtraction operations are defined modulo 2, differences of the shares may be computed using an XOR operation, Dⱼ=Vⱼ⊕Wⱼ). In some implementations, e.g., where the size N of an NTT (or some other transform) supported by a hardware accelerator exceeds the dimension of the vectors 210, 212, segmentation 230 may split each difference share Dⱼ into n=d/N blocks (or into n=┌d/N┐ blocks, if d/N is non-integer) enumerated with superscript k herein:

$${D}_{j} \to \{ {D}_{j}^{( k )} \} .$$

Operations 200 may include randomization 240 of the shares and blocks of the vectors prior to using the shares/blocks as inputs into a linear transform 250. In one example implementation, a random value generator 245 may generate n random N×1 vectors r^{(k)}, and randomization 240 may compute pointwise (elementwise) multiplication products

$${r}^{( k )} ∘ {D}_{j}^{( k )}$$

for each share. In some implementations, e.g., in Kyber applications, pointwise products may be computed using pairs of elements. More specifically, a pair of elements of each vector, e.g., r₀ and r₁ may be combined into a linear polynomial r₁x+r₀ and multiplied by a corresponding polynomial constructed using a respective pair of elements of the difference vector D₁x+D₀ modulo a suitably chosen quadratic polynomial x²+C. (The value C may be chosen to be one of twiddle factors for the respective elements, in the instance of an NTT.) In some implementations, random vectors r^{(k)} may be selected to have non-zero elements (e.g., to eliminate instances of accidental zeros occurring during operations 200). Elements of random vectors r^{(k)} may be randomly or pseudorandomly selected from a suitable distribution, which may be a uniform distribution, in some implementations. In other implementations, the distribution may be a high-entropy distribution that is not fully uniform. Different elements of random vectors r^{(k)} may be sampled (generated) independently from each other.

The randomized differences

$${r}^{( k )} ∘ {D}_{j}^{( k )}$$

may be used as an input into linear transform 250, which may be or include a Number Theoretical Transform (NTT), inverse NTT, Fast Fourier Transform (FTT), inverse FTT, Additive Fast Fourier Transform, Reed-Solomon code transform, and/or some other linear transform corresponding to a maximum distance separable (MDS) matrix. The linear transform 250 may amount to multiplication by a suitable d×d transformation matrix T and may output a transformed difference 252

$${TD}_{j}^{( k )} = T * [ {r}^{( k )} ∘ {D}_{j}^{( k )} ]$$

for each block k and for each share j. In some implementations, linear transform 250 may compute p elements (e.g., the first p elements) of each transformed difference 252 TDⱼ^{(k)}, such as p=8, 16, or some other number of elements of the linear transform 250. In some implementations, re-randomization 260 may additionally be performed on the transformed differences 252. More specifically, random value generator 245 may generate n random N×1 vectors (or n random p×1 vectors) s^{(k)} with non-zero elements and compute re-randomized differences 262

$${s}^{( k )} ∘ {TD}_{j}^{( k )}$$

(e.g., using elementwise or elementwise-pairwise multiplication).

Block aggregation 270 may aggregate the re-randomized differences 262 by computing

$${TD}_{j} = {\sum }_{k} {s}^{( k )} ∘ {TD}_{j}^{( k )}$$

(or aggregate the transformed differences 252,

$${TD}_{j} = {\sum }_{k} {TD}_{j}^{( k )} ,$$

if re-randomization 260 is not used). Unmasking 280 of the aggregated differences TD=ΣⱼTDⱼ may be performed to compute the transformed difference TD. Verification 290 then determines whether the transformed difference TD is zero or non-zero. In the former case, the determination that the vectors 210 and 212 are equal (V=W) is made and provided to cryptographic application 202. In the latter case, a determination that the vectors 210 and 212 are unequal (V+W) is made and passed to cryptographic application 202.

Multiple variations of operations 200 are within the scope of the instant disclosure. In some implementations, the elementwise multiplications in the calculations of the randomized differences

$${r}^{( k )} ∘ {D}_{j}^{( k )}$$

may be replaced with matrix multiplications

$${R}^{( k )} * {D}_{j}^{( k )}$$

by random N×N matrices R^{(k)} whose elements may also be generated by random value generator 245. In some implementations, such random matrices R^{(k)} may have full rank N, to decrease a likelihood that the transformed difference TD is zero by accident.

In some implementations, the randomized differences

$${r}^{( k )} ∘ {D}_{j}^{( k )} ( or {R}^{( k )} * {D}_{j}^{( k )} )$$

may additionally be obfuscated, e.g.,

$${r}^{( k )} ∘ {D}_{j}^{( k )} + {e}_{j}^{( k )} ,$$

with small random vectors 248

$${e}_{j}^{( k )}$$

generated by random value generator 245. Elements of random vectors 248 may be limited in value to a numbers that are representable by a predetermined number (e.g., eight, four, and/or the like) of the least significant bits. In such implementations, verification 290 may ignore a certain number of the least significant bits, such that a positive determination V=W is made provided that the transformed difference TD does not exceed a predetermined error set in conjunction with the size of errors

$${e}_{j}^{( k )} .$$

In such implementations, verification 290 may be executed as a Learning-with-Errors (LWE) problem.

In some implementations, re-randomization 260 may also be performed using matrix multiplications, e.g., by computing

$${R}^{( k )} * T {D}_{j}^{( k )}$$

instead of

$${s}^{( k )} ∘ T {D}_{j}^{( k )} .$$

In some implementations, randomization 240 and/or re-randomization 260 may be performed iteratively using multiple instances of linear transform 250. For example, in relation to randomization 240, a first linear transform may be applied to

$${r}^{( k )} ∘ {D}_{j}^{( k )} ( or {R}^{( k )} * {D}_{j}^{( k )} ) ,$$

with the result undergoing a second instance of randomization 240, e.g., using a pointwise multiplication by another random vector or a matrix multiplication by a random matrix, followed by another linear transform 250, and so on, for any number of set iterations.

NTT used as part of operations 200 may be a transformation from N-component vector x=(x₀, x₁, . . . x_{N}) to another N-component vector y=(y₀, y₁, . . . y_{N}),

$${y}_{i} = {\sum }_{k = 0}^{N - 1} {x}_{k} {W}_{N}^{i k} mod q ,$$

performed using powers of an Nth principal root of unity W_{N} modulo q. The modulus q may be any suitable number, e.g., q=13×2⁸+1=3329 for Kyber and q=2²³−2¹³+1=8380417 for Dilithium. The inverse NTT transforms vector y=(y₀, y₁, . . . y_{N}) back to vector x=(x₀, x₁, . . . x_{N}):

$${x}_{k} = \frac{1}{N} {\sum }_{i = 0}^{N - 1} {y}_{i} {W}_{N}^{- i k} mod q .$$

Fast NTT algorithms (which may be performed similarly to the Fast Fourier Transform) computes N/2 two-point butterfly transforms in each of log₂ N iterations. Essentially, a fast NTT amounts to computing N/2 two-point transforms in the first iteration followed by computing N/4 four-point transforms in the second iteration, and so on, until the last iteration produces the ultimate n-point NTT.

Although FIG. 2 illustrates an implementation where randomization is performed directly for the difference V−W between the two vectors, in other implementations, operations of any, some, or all blocks 220-270 may be performed separately for vector V and vector W, e.g. with the final subtraction of respective shares being performed as part of unmasking 208.

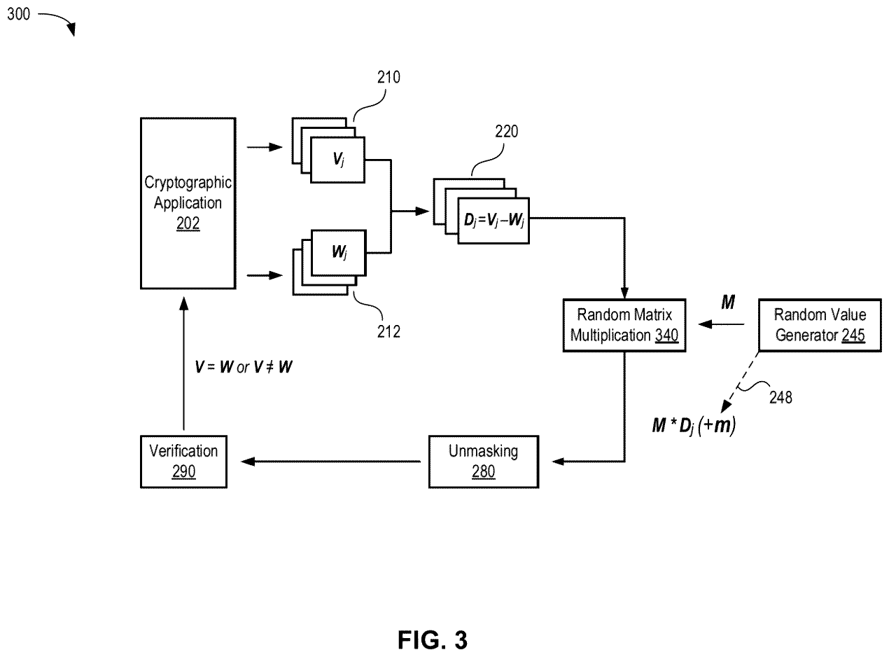

FIG. 3 illustrates schematically another set of operations 300 of randomization-protected comparisons deploying linear transformations, in accordance with one or more aspects of the present disclosure. Operations 300 use multiplication by a random matrix in place of an MSD transform used in operations 200 illustrated in FIG. 2. More specifically, the differences 220 Dⱼ may be multiplied by a random m×d dimensional matrix R to obtain masked differences MDⱼ=R*Dⱼ. In some implementations, a matrix m of small random values 248 may be added to the masked differences, MDⱼ=R*Dⱼ+m, e.g., as described in conjunction with FIG. 2. Other operations illustrated in FIG. 3 may be performed similarly to the respective operations 200 of FIG. 2. In particular, unmasking 280 may be performed to aggregate the masked differences MD=Σⱼ MDⱼ with the verification 290 determining whether the aggregated masked difference MD is zero.

Although FIG. 3 illustrates an implementation where randomization is performed directly for the difference V−W between the two vectors, in other implementations, random matrix multiplication 340 may be performed separately for vector V and vector W, e.g. with the final subtraction of respective shares being performed as part of unmasking 208.

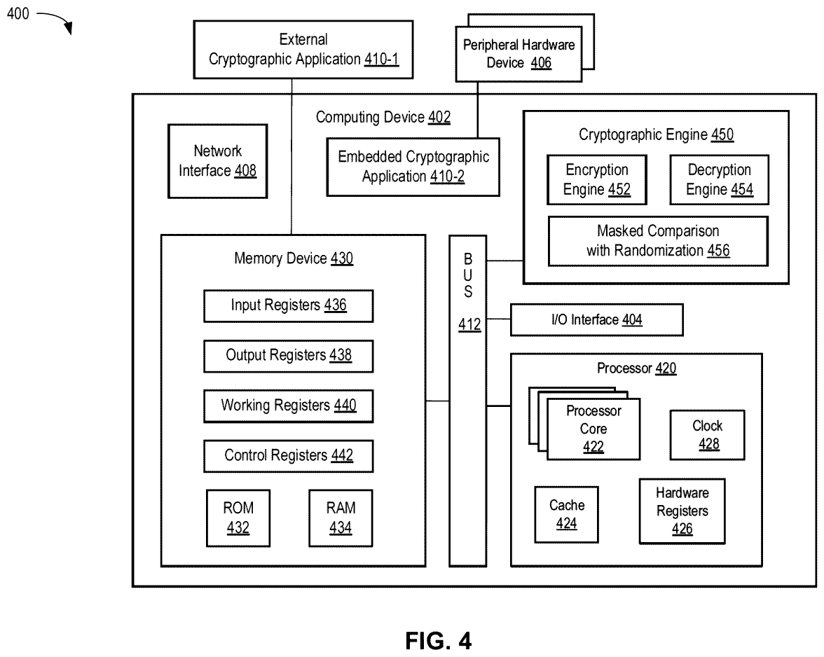

FIG. 4 is a block diagram illustrating an example computing platform 400 capable of supporting randomization-protected comparison operations for efficient implementation of cryptographic applications, in accordance with one or more aspects of the present disclosure. Example computing device 400 may be or include a desktop computer, a tablet, a smartphone, a server (local or remote), a thin/lean client, and the like. Example computing platform 400 may be a smart card reader, a wireless sensor node, an embedded system dedicated to one or more specific applications (e.g., cryptographic applications 410-n), and so on. Example computing platform 400 may include (but need not be limited to) a computing device 402 having one or more processors 420 (e.g., central processing units (CPUs)) capable of executing binary instructions, and one or more memory devices 430. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Computing device 402 may include an input/output (I/O) interface 404 to facilitate connection of computing device 402 with peripheral hardware devices 406, such as card readers, terminals, printers, scanners, internet-of-things devices, and the like. Computing device 402 may further include a network interface 408 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 402. For example, network interface 408 may be used to support a connection to sending device 120 of FIGS. 1A-1B. Various hardware components of computing device 402 may be connected via a bus 412, which may have its own logic circuits.

Example computing platform 400 may support one or more cryptographic applications 410-n, such as one or more external cryptographic applications 410-1 and/or one or more embedded cryptographic applications 410-2. Cryptographic applications 410-n may be secure authentication applications, public key signature applications, key encapsulation applications, key decapsulation applications, encryption applications, decryption applications, fully homomorphic encryption/decryption applications, secure storage applications, and so on. External cryptographic application 410-1 may be instantiated on the same computing device 402, e.g., by an operating system executed by the processor 420 and residing in a memory device 430. Alternatively, external cryptographic application 410-1 may be instantiated by a guest operating system supported by a virtual machine monitor (hypervisor) executed by the processor 420. In some implementations, external cryptographic application 410-1 may reside on a remote access client device or a remote server (not shown), with the computer device 402 providing cryptographic support for the client device and/or the remote server.

Processor 420 may include one or more processor cores 422 having access to cache 424 (e.g., a single-level or multi-level cache) and one or more hardware registers 426. In some implementations, each processor core 422 may execute instructions to run a number of hardware threads, also known as logical processors. Various logical processors (or processor cores) may be assigned to one or more cryptographic applications 410-n, although more than one processor may be assigned to a single cryptographic application for parallel processing. Memory device 430 may refer to a volatile or non-volatile memory and may include a read-only memory (ROM) 432, a random-access memory (RAM) 434, as well as (not shown) electrically erasable programmable read-only memory (EEPROM), flash memory, flip-flop memory, or any other device capable of storing data. RAM 434 may be a dynamic random access memory (DRAM), synchronous DRAM (SDRAM), a static memory, such as static random access memory (SRAM), and the like.

Memory device 430 may include one or more registers, such as one or more input registers 436 to store cryptographic keys, input polynomials, and other data for cryptographic applications 410-n. Memory device 430 may further include one or more output registers 438 to store outputs of cryptographic application, and one or more working registers 440 to store various intermediate values generated in the course of performing cryptographic computations, including masking operations. Memory device 430 may also include one or more control registers 442 for storing information about modes of operation, selecting a cryptographic algorithm, initializing cryptographic computations, selecting a masking mode, selecting ring Z_{q}, performing masking and reverse decomposition, and/or the like. Control registers 442 may communicate with one or more processor cores 422 and a clock 428, which may keep track of a processing operation (e.g., iteration of the NTT/inverse NTT) being performed. In some implementations, registers 436-442 may be implemented as part of RAM 434. In some implementations, some or all of the registers 436-442 may be implemented separately from RAM 434. Some of or all registers 436-442 may be implemented as part of processor 420 (e.g., as part of the hardware registers 426). In some implementations, processor 420 and memory device 430 may be implemented as a single field-programmable gate array (FPGA).

Computing device 402 may include a cryptographic engine 450 to support cryptographic operations of processor 420. Cryptographic engine 450 may be configured to perform digital signature operations, key encapsulation operations, and/or any other applicable cryptographic operations, in accordance with implementations of the present disclosure. As depicted in FIG. 4, cryptographic engine 450 may be a separate hardware component, e.g., an accelerator. In some implementations, cryptographic engine 450 may be implemented as a software (or firmware) module instantiated in memory device 430. In some implementations, cryptographic engine 450 may be partially implemented as a hardware component and partially as a software (or firmware) module. Cryptographic engine 450 may include an encryption engine 452 to encrypt plaintext messages and generate ciphertexts. Cryptographic engine 450 may also include a decryption engine 454 to decrypt ciphertexts and recover plaintext messages. Encryption engine 452 and/or decryption engine 454 may use masked computation with randomization 456 for efficient implementation of cryptographic applications, e.g., as described in more detail in conjunction with FIGS. 1A-1B and FIGS. 2-3 above.

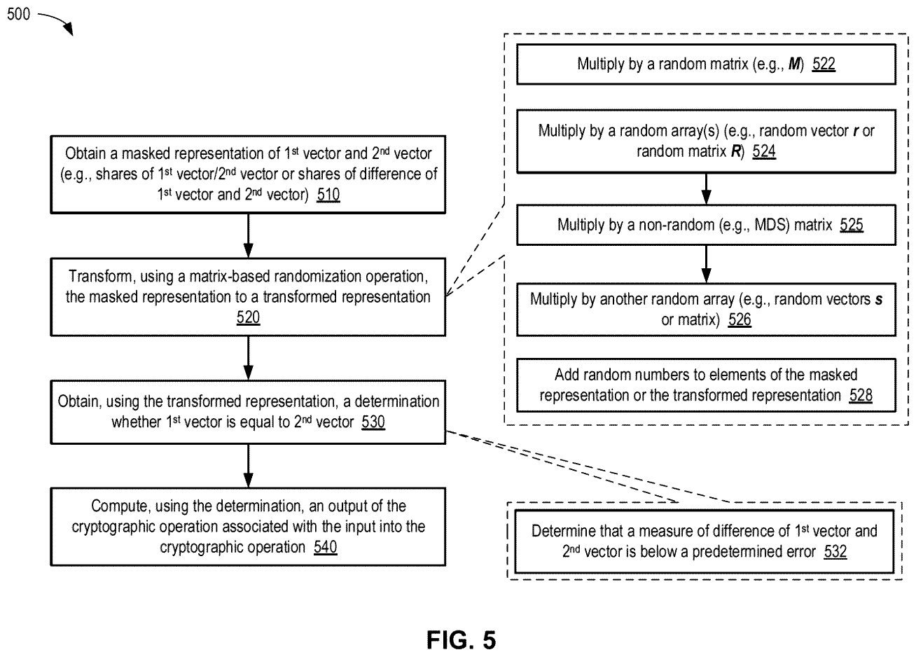

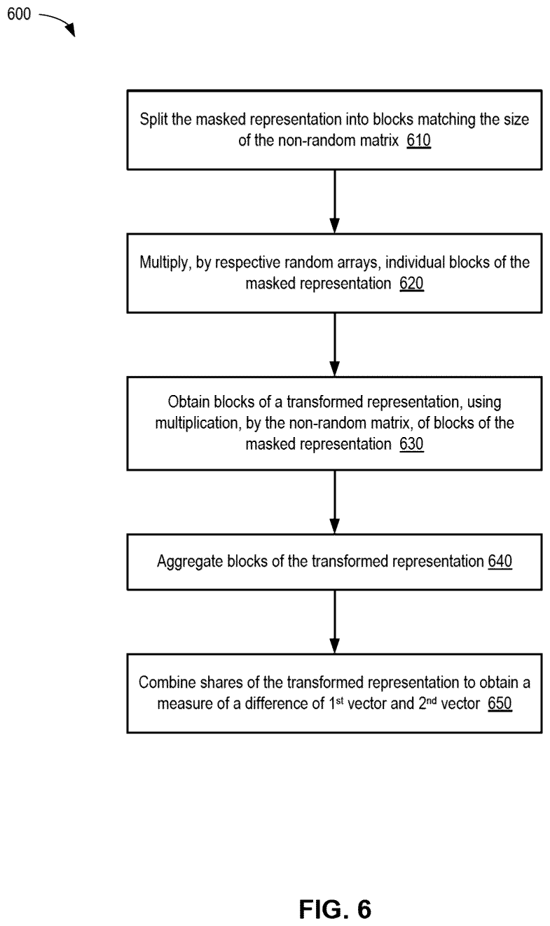

FIGS. 5-6 illustrate methods 500 and 600 directed to randomization-protected comparison operations deploying linear transformations and or matrix multiplications. Methods 500 and/or 600 and any, some, or all of their individual functions, routines, subroutines, or operations may be performed by one or more processing units of a suitable computing system, e.g., by processor 420 and/or cryptographic engine 450 of computing device 402 in FIG. 4. In some implementations, methods 500 and/or 600 may be performed by an arithmetic logic unit, an FPGA, an ASIC, a cryptographic accelerator, a dedicated hardware circuit, and the like, or any suitable processing logic, hardware or software or a combination thereof. In certain implementations, methods 500 and/or 600 may be performed by a single processing thread. Alternatively, methods 500 and/or 600 may be performed by two or more processing threads, each thread executing one or more individual functions, routines, subroutines, or operations of the method. In an illustrative example, the processing threads implementing methods 500 and/or 600 may be synchronized (e.g., using semaphores, critical sections, and/or other thread synchronization mechanisms). Alternatively, the processing threads implementing methods 500 and/or 600 may be executed asynchronously with respect to each other. Various operations of methods 500 and/or 600 may be performed in a different order compared with the order shown in FIG. 5 and/or FIG. 6. Some blocks of methods 500 and/or 600 may be performed concurrently with other blocks. Some blocks of methods 500 and/or 600 may be optional.

FIG. 5 depicts a flow diagram of an example method 500 of using randomization-protected comparison operations deploying linear transformations and or matrix multiplications in cryptographic applications, in accordance with one or more aspects of the present disclosure. In some implementations, method 500 may be performed to process (or as part of processing) an input into a cryptographic operation. In some implementations, the cryptographic operation may include a digital signature operation, an plaintext encryption operation, a ciphertext decryption operation, a key encapsulation operation, and/or the like.

In some implementations, as illustrated in FIG. 5, method 500 may include, at block 510, obtaining a masked representation of a first vector (e.g., vector V) and a second vector (e.g., vector W). For example, the masked representation of the first vector and the second vector may be obtained as part of processing an input into the cryptographic operation. The masked representation may include a first plurality of shares of the first vector (e.g., shares V₁, V₂, . . . ) and a second plurality of shares of the second vector (e.g., shares W₁, W₂, . . . ) or a plurality of shares of a difference of the first vector and the second vector (e.g., difference shares D₁=V₁−W₁, D₂=V₂−W₂, . . . ).

At block 520, method 500 may include transforming, using a matrix-based randomization operation, the masked representation to a transformed representation. In some implementations, the matrix-based randomization operation of block 520 may include at least some of the sub-operations illustrated in the top callout portion of FIG. 5. For example, as illustrated with block 522, the matrix-based randomization operation may include multiplication by a random matrix (e.g., M, as disclosed in conjunction with FIG. 3). In some implementations, the matrix may be applied to the shares of each vector separately (e.g., shares of the first vector, M*V₁, M*V₂, . . . , and shares of the second vector, M*W₁, M*W₂, . . . ). In other implementations, the random matrix may be applied to the difference of the shares (e.g., M*D₁, M*D₂, . . . ).

In some implementations, the matrix-based randomization operation may include, as illustrated with blocks 524-526, multiplication by a non-random matrix, e.g., a matrix that implements an NTT, an inverse NTT, an FFT, an inverse FFT, an additive FFT, an inverse additive FFT, a Reed-Solomon code matrix, and/or some other maximum distance separable (MDS) matrix. More specifically at block 524, the matrix-based randomization operation may include multiplication by one or more random arrays, such as pointwise multiplications by a random vector (e.g., r∘Dⱼ), a random matrix (e.g., matrix multiplications, R*Dⱼ). At block 525, multiplication by the non-random matrix may be performed. In some implementations, as illustrated with block 526, multiplication by another random array (e.g., vectors s^{(k)} or another random matrix) may be performed.

In some implementations, as illustrated with block 528, the matrix-based randomization operation may also include addition of random numbers to elements to the masked representation (e.g., prior to multiplication by the random matrix at block 522, by random arrays at block 525, and/or by the non-random matrix at block 526) or to the transformed representation (e.g., after multiplication by the random matrix at block 522 or by non-random matrix at block 524, e.g., r∘Dⱼ+eⱼ). In some implementations, the random numbers may be set not to exceed a specific threshold (e.g., may be limited numbers represented by a certain number of bits).

At block 530, method 500 may include obtaining, using the transformed representation, a determination whether the first vector is equal to the second vector. In those implementations that deploy the use of random numbers of block 528, obtaining the determination may include, as illustrated with the callout block 532, determining that a measure of a difference of the first vector and a second vector is below a predetermined error.

At block 540, method 500 may include computing, using the determination, an output of the cryptographic operation associated with the input into the cryptographic operation. In some implementations, the output of the cryptographic operation may include a digital signature for the input into the cryptographic operation, an encryption of the input into the cryptographic operation, a decryption of the input into the cryptographic operation, and/or other suitable cryptographic operations.

FIG. 6 depicts a flow diagram of an example method 600 of implementing randomization-protected comparison operations that deploy linear transformations and or matrix multiplications in conjunction with splitting into blocks, in accordance with one or more aspects of the present disclosure. In some implementations, operations of method 600 may be performed in those instances of method 500 that include multiplications by non-random matrices (as illustrated with block 524 of FIG. 5) and where a size of the non-random matrix (e.g., N, as supported by a hardware accelerator) is less than a size of the first vector (e.g., d).

At block 610, operations of method 600 may include splitting the masked representation into a plurality of blocks matching the size of the non-random matrix (e.g., splitting

$${V}_{j} \to \{ {V}_{j}^{( k )} \} , {W}_{j} \to \{ {W}_{j}^{( k )} \} , and / or {D}_{j} \to \{ {D}_{j}^{( k )} \} ,$$

each block having N or fewer elements);

in those instances where the last block has fewer than N elements, the missing elements of the last block may be padded with zeros).

At blocks 620-630, operations of method 600 may include multiplying, by a respective random array (e.g., random vector r^{(k)} with reference to FIG. 2) of one or more random arrays (e.g., a set of random vectors {r^{(k)}}), a corresponding block of the masked representation (e.g., multiplying

$${D}_{j}^{( k )}$$

to obtain

$${r}^{( k )} ∘ {D}_{j}^{( k )} ,$$

as part of randomization 240 in FIG. 2).

At block 630, method 600 may continue with obtaining a plurality of blocks of the transformed representation, an individual block of the transformed representation obtained by multiplication, by the non-random matrix, of a respective block of the plurality of blocks of the masked representation (e.g., computing

$$T {D}_{j}^{( k )} = T * [ {D}_{j}^{( k )} ] , T {D}_{j}^{( k )} = T * [ {r}^{( k )} ∘ {D}_{j}^{( k )} ] ,$$

and/or the like). In some implementations, operations of block 630 may further include re-randomization of the blocks of the transformed representation (e.g., multiplication by random vector s^{(k)} with reference to FIG. 2) of one or more additional random arrays (e.g., a set of random vectors {r^{(k)}} to obtain

$${s}^{( k )} ∘ T {D}_{j}^{( k )} ,$$

as part of re-randomization 260 in FIG. 2).

At block 640, method 600 may include aggregating the plurality of blocks of the transformed representation (e.g., summing the transformed differences,

$${\sum }_{k} T {D}_{j}^{( k )} ,$$

or summing the transformed first and second vectors,

$${\sum }_{k} T {V}_{j}^{( k )} and {\sum }_{k} T {W}_{j}^{( k )} ,$$

as part of block aggregation 270 in FIG. 2).

At block 650, operations of method 600 may include combining shares of the transformed representation to obtain a measure of a difference of the first vector and a second vector (e.g., computing Σⱼ TDⱼ or computing Σⱼ TVⱼ−Eⱼ TWⱼ, as part of unmasking 270 in FIG. 2). Operations of method 600 and/or block 530 of method 500 may further include comparing the obtained measure to zero.

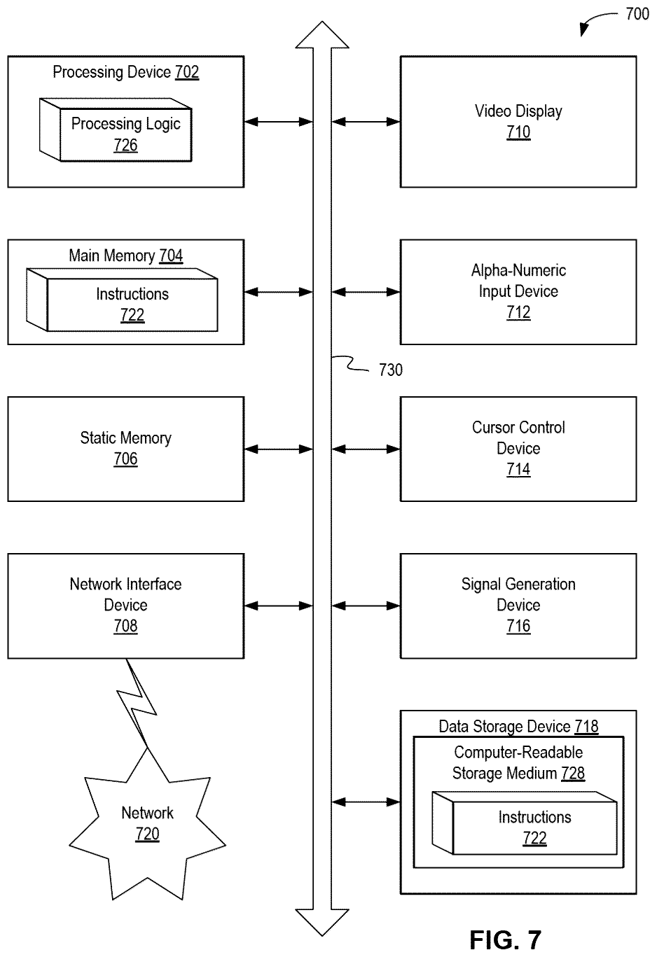

FIG. 7 depicts a block diagram of an example computer system 700 operating in accordance with one or more aspects of the present disclosure. In various illustrative examples, computer system 700 may represent computing device 402, illustrated in FIG. 4. Example computer system 700 may be connected to other computer systems in a LAN, an intranet, an extranet, and/or the Internet. Computer system 700 may operate in the capacity of a server in a client-server network environment. Computer system 700 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 700 may include a processing device 702 (also referred to as a processor or CPU), which may include processing logic 726, a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which may communicate with each other via a bus 730.

Processing device 702 represents one or more general-purpose processing devices such as a microprocessor, central processing unit, or the like. More particularly, processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 702 may be configured to execute instructions implementing example methods 500 and/or 600 of randomization-protected comparison operations deploying linear transformations and or matrix multiplications.

Example computer system 700 may further comprise a network interface device 708, which may be communicatively coupled to a network 720. Example computer system 700 may further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Data storage device 718 may include a computer-readable storage medium (or, more specifically, a non-transitory computer-readable storage medium) 728 on which is stored one or more sets of executable instructions 722. In accordance with one or more aspects of the present disclosure, executable instructions 722 may comprise executable instructions implementing example methods 500 and/or 600 of randomization-protected comparison operations deploying linear transformations and or matrix multiplications.

Executable instructions 722 may also reside, completely or at least partially, within main memory 704 and/or within processing device 702 during execution thereof by example computer system 700, main memory 704 and processing device 702 also constituting computer-readable storage media. Executable instructions 722 may further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to process an input into a cryptographic operation, the method comprising:
obtaining, by a processing device, a masked representation of a first vector and a second vector, wherein the masked representation comprises at least one of:
a first plurality of shares of the first vector and a second plurality of shares of the second vector, or
a plurality of shares of a difference of the first vector and the second vector;
transforming, by the processing device and using a matrix-based randomization operation, the masked representation to a transformed representation;
obtaining, using the transformed representation, a determination whether the first vector is equal to the second vector; and
computing, by the processing device and using the determination, an output of the cryptographic operation associated with the input into the cryptographic operation.

2. The method of claim 1, wherein the output of the cryptographic operation comprises at least one of:
a digital signature for the input into the cryptographic operation,
an encryption of the input into the cryptographic operation, or
a decryption of the input into the cryptographic operation.

3. The method of claim 1, wherein the matrix-based randomization operation comprises:
multiplication by a random matrix.

4. The method of claim 1, wherein the matrix-based randomization operation comprises:
multiplication by one or more random arrays, wherein the one or more random arrays comprise at least one of: a random vector or a random matrix, and
multiplication by a non-random matrix.

5. The method of claim 4, the non-random matrix comprises a maximum distance separable matrix.

6. The method of claim 4, wherein a size of the non-random matrix is less than a size of the first vector, wherein the matrix-based randomization operation further comprises:
splitting the masked representation into a plurality of blocks matching the size of the non-random matrix; and
obtaining a plurality of blocks of the transformed representation, an individual block of the transformed representation obtained by multiplication, by the non-random matrix, of a respective block of the plurality of blocks of the masked representation.

7. The method of claim 6, wherein the matrix-based randomization operation further comprises:
multiplying, by a respective random array of one or more random arrays, a corresponding block of at least one of:
the plurality of blocks of the masked representation, or
the plurality of blocks of the transformed representation.

8. The method of claim 7, wherein obtaining the determination comprises:
aggregating the plurality of blocks of the transformed representation.

9. The method of claim 1, wherein obtaining the determination comprises:
combining shares of the transformed representation to obtain a measure of a difference of the first vector and a second vector; and
comparing the obtained measure to zero.

10. The method of claim 1, wherein performing the matrix-based randomization operation comprising:
adding random numbers to elements of at least one of: the masked representation or the transformed representation, the random numbers not exceeding a set threshold; and
wherein obtaining the determination comprises:
determining that a measure of a difference of the first vector and a second vector is below a predetermined error.

11. A processing device comprising:
one or more registers to store a masked representation of a first vector and a second vector, wherein the first vector and the second vector are associated with an input into a cryptographic operation, and wherein the masked representation comprises at least one of:
a first plurality of shares of the first vector and a second plurality of shares of the second vector, or
a plurality of shares of a difference of the first vector and the second vector; and
one or more processing units communicatively coupled to the one or more registers, the one or more processing units to:
transform, using a matrix-based randomization operation, the masked representation to a transformed representation;
obtain, using the transformed representation, a determination whether the first vector is equal to the second vector; and
compute, using the determination, an output of the cryptographic operation associated with the input into the cryptographic operation.

12. The processing device of claim 11, wherein the output of the cryptographic operation comprises at least one of:
a digital signature for the input into the cryptographic operation,
an encryption of the input into the cryptographic operation, or
a decryption of the input into the cryptographic operation.

13. The processing device of claim 11, wherein the matrix-based randomization operation comprises:
multiplication by a non-random matrix, and
multiplication by one or more random arrays, wherein the one or more random arrays comprise at least one of: a random vector or a random matrix.

14. The processing device of claim 13, wherein the processing device further comprises an accelerator circuitry to perform the multiplication by the non-random matrix.

15. The processing device of claim 13, the non-random matrix comprises a maximum distance separable matrix.

16. The processing device of claim 13, wherein a size of the non-random matrix is less than a size of the first vector, wherein the matrix-based randomization operation further comprises:
splitting the masked representation into a plurality of blocks matching the size of the non-random matrix; and
obtaining a plurality of blocks of the transformed representation, an individual block of the transformed representation obtained by multiplication, by the non-random matrix, of a respective block of the plurality of blocks of the masked representation.

17. The processing device of claim 16, wherein the matrix-based randomization operation further comprises:
multiplying, by a respective random array of one or more random arrays, a corresponding block of at least one of:
the plurality of blocks of the masked representation, or
the plurality of blocks of the transformed representation; and
aggregating the plurality of blocks of the transformed representation.

18. The processing device of claim 11, wherein to obtain the determination, the one or more processing units are to:
combine shares of the transformed representation to obtain a measure of a difference of the first vector and a second vector; and
compare the obtained measure to zero.

19. The processing device of claim 11, wherein to perform the matrix-based randomization operation, the one or more processing units are to:
add random numbers to elements of at least one of: the masked representation or the transformed representation, the random numbers not exceeding a set threshold; and
wherein obtaining the determination comprises:
determine that a measure of a difference of the first vector and a second vector is below a predetermined error.

20. A non-transitory computer-readable memory storing instructions that, when executed by a processing device, cause the processing device to perform operations comprising:
processing an input into a cryptographic operation to obtain a masked representation of a first vector and a second vector, wherein the masked representation comprises at least one of:
a first plurality of shares of the first vector and a second plurality of shares of the second vector, or
a plurality of shares of a difference of the first vector and the second vector;
transforming, by the processing device and using a matrix-based randomization operation, the masked representation to a transformed representation;
obtaining, using the transformed representation, a determination whether the first vector is equal to the second vector; and
computing, by the processing device and using the determination, an output of a cryptographic operation associated with the input into the cryptographic operation.
